(19) United States
(12) Patent Application Publication
(10) Pub. No.: US 2006/0143011 A1
(43) Pub. Date: Jun. 29, 2006

(54) Information processing apparatus and information processing system

(75) Inventor: Michihiro Kawamura, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD, Tokyo (JP)

(21) Appl. No.: 11/127,215

(22) Filed: May 12, 2005

(30) Foreign Application Priority Data
Nov. 30, 2004 (JP) 2004-345499

(51) Int. Cl. G10L 13/08

(52) U.S. Cl. 704/260

(57) ABSTRACT

An information processing apparatus comprises a first timer that times a first time; a second timer that times a second time which is different from the first time; and a switching unit that switches, in accordance with a user, between a first power saving control mode in which shift is made to the power saving mode if no operation is performed for a period of the first time, and a second power saving control mode in which shift is made to the power saving mode if no operation is performed for a period of the second time timed by the second timer.

### TECHNOLOGICAL FIELD

The present invention relates to an information processing system which enables a visually-impaired person to operate an information processing apparatus having various functions by guiding him/her on the operations of the information processing apparatus by voice, and particularly to an information processing system with a power saving control function and an auto-clear function which can be used by both an able-bodied person and a visually-impaired person comfortably.

### RELATED ART

Recently, an information processing apparatus comes to have various functions such as a duplication function, facsimile function, printer function, and scanning function. Such information processing apparatus can no longer be operated only by using the numeric keypad or function keys due to the diversified functions to be handled. Thus, a touch-panel input method has been prevalent, in which a touch panel is provided on a display and letters and characters showing the operation procedure or pictures illustrating an input place etc. are displayed on the screen so that a user performs input by touching an input area.

However, it is difficult, for example, for a visually-impaired person to perform operations since he/she has a problem in visually recognizing functional touch areas on the touch panel, and thus have to memorize the operation procedure and the locations of the touch areas beforehand in order to perform the operations.

In order to solve this problem, there is a device which enables a visually-impaired person to operate an information processing apparatus, which involves complicated operations, by guiding him/her by voice using a voice synthesizer.

Generally, an information processing apparatus is provided with a function called “auto-clear” that changes the settings back to the initial setting by initializing the screen if no operation is performed by an operator for more than a fixed period of time, and a power saving control function that can reduce consumption in the electricity by fading out the display or by shifting to a sate called “power saving mode” in which the operations of the equipment are partially restrained if no operation is performed by the operator for more than a fixed period of time.

However, it is usually the case that it takes a longer time required for a visually-impaired person to perform a work operation than an able-bodied person. Therefore, if the time for moving to the auto-clear and the time for shifting to the power saving mode are set for an able-bodied person, i.e. set in a time comfortable for the able-bodied person, the auto-clear is executed so that the setting is changed back to the initial setting while the visually-impaired person is still operating the equipment, whereby it was difficult for the visually-impaired person to use the equipment.

On the other hand, if the time for executing the auto-clear is set in a time comfortable for the visually-impaired person, i.e., set in a time longer for the visually-impaired person, there occurs a problem that an able-bodied person who might use the equipment next may accidentally copy the parameter which was set by the previous able-bodied user, whereby the effect of the auto-clear wanes.

### SUMMARY OF THE INVENTION

According to an aspect of the present invention, an information processing apparatus comprises a first timer that times a first time; a second timer that times a second time which is different from the first time; and a switching unit that switches, in accordance with a user, between a first power saving control mode in which shift is made to the power saving mode if no operation is performed for a period of the first time, and a second power saving control mode in which shift is made to the power saving mode if no operation is performed for a period of the second time timed by the second timer.

### BRIEF DESCRIPTION OF THE DRAWINGS

Embodiments of the present invention will be described in detail based on the following figures, wherein:

FIG. 1 is a diagram schematically illustrating a configuration of an information processing system according to an embodiment of the present invention;

FIG. 2 is a block diagram illustrating an example of the configuration of an image forming apparatus 10 in the embodiment;

FIG. 3 is a block diagram illustrating an example of the configuration of a voice guiding apparatus 20 in the embodiment;

FIG. 4 is a diagram illustrating a UI screen 400 of an application for a voice guide, the UI screen 400 being displayed on a display 301 of the voice guiding apparatus 20;

FIG. 5 is a flow chart illustrating a processing flow in the voice guiding apparatus 20 when connecting the voice guiding apparatus 20 to the image forming apparatus 10 using a USB cable 30;

FIG. 6 is a flow chart illustrating a processing flow in the image forming apparatus 10 after the voice guiding apparatus 20 is connected to the image forming apparatus 10 by using the USB cable, the image forming apparatus 10 entering the power saving mode;

FIG. 7 is a flow chart illustrating a flow of processing of the image forming apparatus 10, which is executed when inserting a connector of the USB cable 30 connected to the voice guiding apparatus 20 into the image forming apparatus 10 shifting to the power saving mode;

FIG. 8 is a sequence diagram illustrating an outline of a processing being executed by the image forming apparatus 10 and voice guiding apparatus 20 until the auto-clear is executed on the image forming apparatus 10 when a visually-impaired person operates the image forming apparatus 10 using the voice guiding apparatus 20 in the information processing system 100;

FIG. 9 is a flow chart illustrating a flow of processing in the image forming apparatus 10 until the auto-clear is executed on the image forming apparatus 10;

FIG. 10 is a flow chart illustrating a flow of processing in the image forming apparatus 10 until the auto-clear is executed on the image forming apparatus 10;

FIG. 11 is a flow chart illustrating a flow of processing in the voice guiding apparatus 20 until the auto-clear is executed on the information processing system 100;

FIG. 12 is a sequence diagram illustrating an outline of processing being executed by the image forming apparatus 10 and voice guiding apparatus 20 until the image forming apparatus 10 is shifted to the power saving mode when a visually-impaired person operates the image forming apparatus 10 using the voice guiding apparatus 20 in the information processing system 100;

FIG. 13 is a flow chart illustrating a flow of processing in the image forming apparatus 10 until the image forming apparatus 10 is shifted to the power saving mode;

FIG. 14 is a flow chart illustrating a flow of processing in the image forming apparatus 10 until the image forming apparatus 10 is shifted to the power saving mode;

FIG. 15 is a flow chart illustrating a flow of processing in the voice guiding apparatus 20 until the image forming apparatus 10 is shifted to the power saving mode in the information processing system 100;

FIG. 16 is a system configuration diagram illustrating an outline of an information processing system 1600 according to another embodiment of the present invention;

FIG. 17 is a block diagram illustrating an example of a configuration of the image forming apparatus 1610 in the another embodiment;

FIG. 18 is a block diagram illustrating an example of a configuration of a voice guiding apparatus 1620 in the another embodiment;

FIG. 19 is a flow chart shoring a flow of processing in the voice guiding apparatus 1620 until auto-clear is executed on the information processing system 1600; and

FIG. 20 is a flow chart illustrating a flow of processing in the voice guiding apparatus 1620 until the image forming apparatus 1610 is shifted to the power saving mode in the information processing system 1600.

### DESCRIPTION OF THE EMBODIMENTS

Embodiments of the information processing apparatus and information processing system according to the present invention will now be described in detail with reference to the attached drawings.

### Embodiment 1

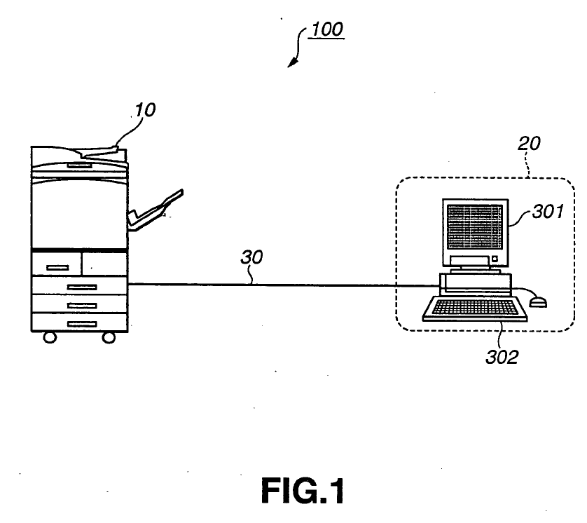

FIG. 1 is a diagram schematically illustrating a configuration of an information processing system according to an embodiment of the present invention.

As shown in FIG. 1, in an information processing system 100 related to the present invention, an image forming apparatus 10 is equipped with two timers, for example, for an able-bodied person and a visually-impaired person, and a voice guiding apparatus 20 is connected to the image forming apparatus 10 by means of a USB cable.

The image forming apparatus 10 comprises plural functions such as a duplication function, facsimile function, scanning function and the like.

Further, the voice guiding apparatus 20 is constituted with a personal computer, has an application for a voice guide installed therein so that an visually-impaired person can operated the image forming apparatus 10, and is constituted such that the application for a voice guide inputted from an input device 302 and operated is displayed on a display 301.

A visually-impaired person uses the personal computer which constitutes the voice guiding apparatus 20 to operate the image forming apparatus 10, and an able-bodied person uses a touch panel, which is a user interface (abbreviated as “UI” hereinafter) attached onto the image forming apparatus 10, to operate the image forming apparatus 10.

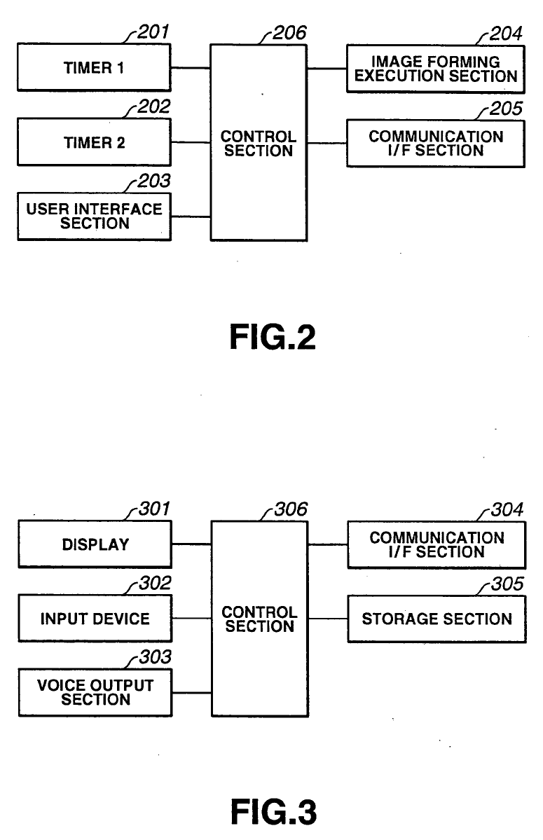

The image forming apparatus 10 and the voice guiding apparatus 20 are connected by the USB cable and exchange information. Next, an outline of the configuration of the image forming apparatus 10 is explained with reference to FIG. 2.

FIG. 2 is a block diagram illustrating an example of the configuration of the image forming apparatus 10 in the present embodiment.

The image forming apparatus 10 is constituted by a timer 1-201 described in Claims 1 and 3, which is a timer for timing a first time and for informing an able-bodied person of the passage of time taken for auto-clear and for making the shift to the power saving mode, a timer 2-202 described in Claims 1 and 3, which is a timer for timing a second time and for informing a visually-impaired person of the passage of time taken for auto-clear and for making the shift to the power saving mode, a user interface section 203 which is a touch panel screen on which the able-bodied person performs various parameter settings in an image forming processing, an image forming execution section 204 which is responsible for various image forming functions such as a duplication function, facsimile function, scanning function, copy function and the like in the image forming apparatus 10, a communication interface section 205 (abbreviated as “communication I/F section 205” hereinafter) to which a connector of the USB cable is connected from the voice guiding apparatus 20 is connected so as to exchange information with the voice guiding apparatus 20, and a control section 206 which is connected to each constituent section and controls each constituent section.

If the USB cable 30 is connected from the voice guiding apparatus 20 to the communication I/F section 205, the control section 206 can detect the connection.

Next, an outline of the configuration of the voice guiding apparatus 20 is explained with reference to FIG. 3.

FIG. 3 is a block diagram illustrating an example of the configuration of the voice guiding apparatus 20 in the present embodiment.

The voice guiding apparatus 20 is constituted by the display 301 which is responsible for functions including display of the UI screen of the application for a voice guide to the visually-impaired person, an input device 302 such as a keyboard serving as a device in which the visually-impaired person inputs information into the UI screen, a voice output section 303 for informing, for example, the visually-impaired person of an operational state on the UI screen displayed on the display 301, by voice, in order for an operation of the image forming apparatus 10, a communication interface section 304 (abbreviated as “communication I/F section 304” hereinafter) which is connected to the image forming apparatus 10 by the USB cable 30 and exchanges information with the image forming apparatus 10, a storage section 305 in which the application for a voice guide is stored, and a control section 306 which is connected to each constituent section and controls each constituent section.

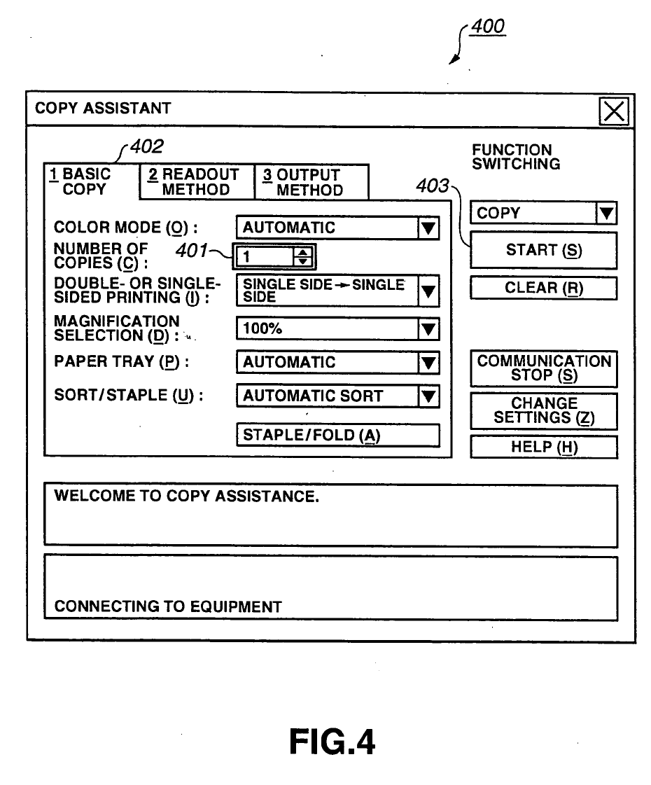

Next, the UI screen displayed on the display 301 of the voice guiding apparatus 20 is now explained with reference to FIG. 4.

FIG. 4 is a screen configuration diagram illustrating a UI screen 400 of the application for a voice guide, the UI screen 400 being displayed on the display 301 of the voice guiding apparatus 20.

The UI screen 400 is a UI screen which is displayed on the display 301 of the voice guiding apparatus 20, performs various parameter setting of the image forming apparatus 10, and where the visually-impaired person can operate the image forming apparatus 10.

On the UI screen 400, by moving a button or the like focused on the screen using the Tab key, the settings or the like for the focused button is voice outputted so that even the visually-impaired person can operate the image forming apparatus 10 using the UI screen 400.

Regarding the contents of the UI screen 400, “1 basic copy tab 202” is selected for a tab for selecting the actual setting items. On the screen displayed by the 1 basic copy tab 202, setting for color mode, the number of copies, selection of double- or single-sided printing, magnification selection, tray, and sort/staple can be performed.

For example, by selecting an edit box 401 for “the number of copies” with the press of the Tab key of the input device 302, a voice guide of “please specify the number of copies, Alt-C, edit box, one, using the numeric keys or the up and down arrow keys” is voice outputted by the voice output section 303.

The visually-impaired person hears the outputted voice guide, and, when wishing to change the settings, changes the settings to desired set values by using the numeric keys or the up and down arrow keys in accordance with the voice guide.

When wishing to confirm the set values again, by pressing a specific key (F2 key, for example), a voice, “the number of copies is 1,” which is the numeric value set in the edit box 401 for the number of copies focused in the UI screen 400, is outputted.

In this manner basically, it is possible to cause the image forming apparatus 10 to execute copy or the like by changing the focused item with the press of the Tab key, setting the contents of the item to desired set values in accordance with the setting method to be read, setting the detailed parameter, selecting a start button 403 with the press of the Tab key again, and pressing Enter key from the input device 302.

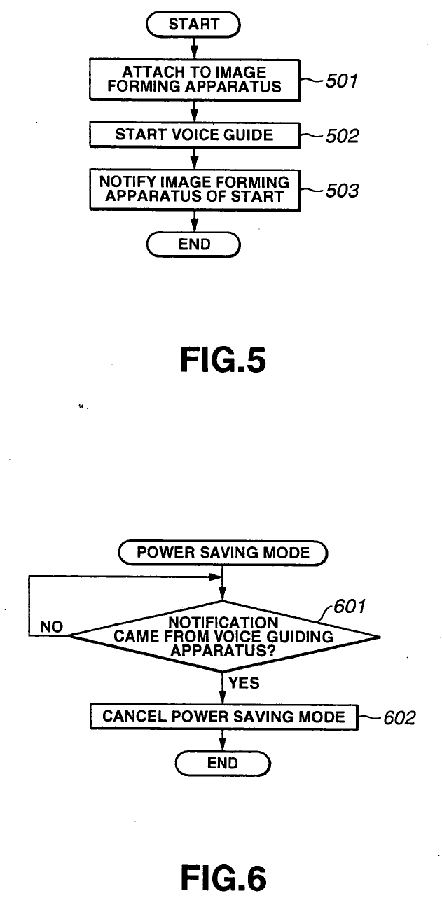

Next, a processing of the voice guiding apparatus 20, which is executed when connecting the voice guiding apparatus 20 to the image forming apparatus 10 using the USB cable 30, is explained with reference to FIG. 5.

FIG. 5 is a flow chart illustrating a processing flow in the voice guiding apparatus 20 when connecting the voice guiding apparatus 20 to the image forming apparatus 10 using the USB cable 30.

First, the visually-impaired person connects the voice guiding apparatus 20 to the image forming apparatus 10 using the USB cable 30 when wishing to operate the image forming apparatus 10 (Step 501).

The image forming apparatus 10 may or may not enter the power saving mode when the voice guiding apparatus 20 is connected thereto.

Once the image forming apparatus 10 is connected to the voice guiding apparatus 20, the visually-impaired person turns on the power of the voice guiding apparatus 20 to start up a voice guide (Step 502).

Once the voice guided is started up, the fact that the voice guide has been started up is informed from the voice guiding apparatus 20 to the image forming apparatus 10 (Step 503).

In this manner, when the voice guiding apparatus 20 is connected and started up, the image forming apparatus 10 is notified of that effect.

Next, a processing of the image forming apparatus 10, which is executed when using the USB cable 30 to connect the voice guiding apparatus 20 to the image forming apparatus 10 shifting to the power saving mode, is explained with reference to FIG. 6.

FIG. 6 is a flow chart illustrating a processing flow in the image forming apparatus 10 after the voice guiding apparatus 20 is connected to the image forming apparatus 10 by using the USB cable, the image forming apparatus 10 entering the power saving.

As was explained with reference to FIG. 5, regardless of whether or not the image forming apparatus 10 is shifting to the power saving mode, when the voice guiding apparatus 20 is connected and started up, a notification that the voice guiding apparatus 20 is started is transmitted from the voice guiding apparatus 20 to the image forming apparatus 10.

Then, the image forming apparatus 10 receives the notification that the voice guiding apparatus 20 is started (Step 601).

The image forming apparatus 10 receives the notification from the voice guiding apparatus 20 that the voice guide is started, the control potion 206 confirms that a communication is established between the voice guiding apparatus 20 and the image forming apparatus 10, and the image forming apparatus 10 executes a processing for canceling the power saving mode of the image forming apparatus 10 (Step 602).

Note that the image forming apparatus 10 which is shifting to the power saving mode does not receive the notification that the voice guiding apparatus 20 has been started up, but receives information about the operation of the voice guiding apparatus 20. Moreover, even when a communication is established between the image forming apparatus 10 and the voice guiding apparatus 20, the image forming apparatus 10 which is shifting to the power saving mode cancels the power saving mode.

At this time, the voice guiding apparatus 20 transmits the information about the operation to the image forming apparatus 10 every time the application for a voice guide is operated.

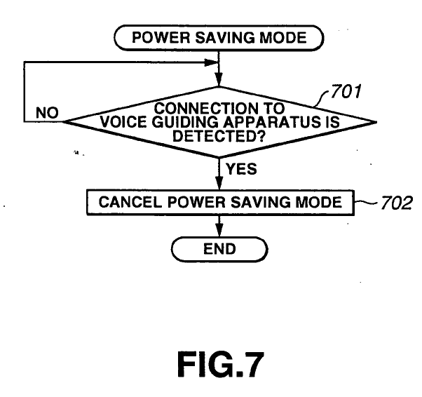

Next, a processing in the image forming apparatus 10, which is executed when inserting the connector of the USB cable 30 from the voice guiding apparatus 20 into the image forming apparatus 10 shifting to the power saving mode, is explained with reference to FIG. 7.

FIG. 7 is a flow chart illustrating a flow of processing of the image forming apparatus 10, which is executed when inserting the connector of the USB cable 30 connected to the voice guiding apparatus 20 into the image forming apparatus 10 shifting to the image forming apparatus 10.

When the image forming apparatus 10 in the power saving mode detects that the connector of the USB cable 30 which is connected to the voice guiding apparatus 20 is inserted (Step 701), the power saving mode is canceled (Step 702).

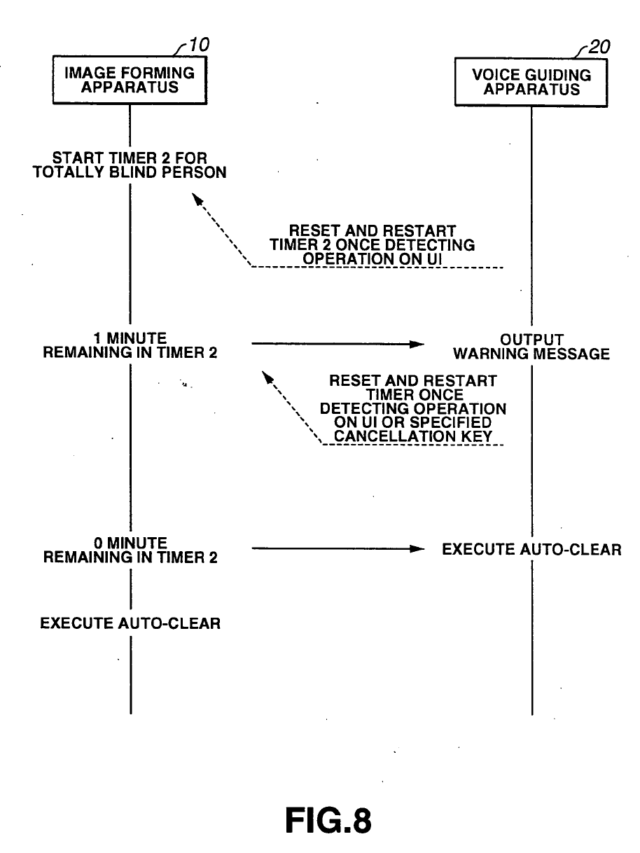

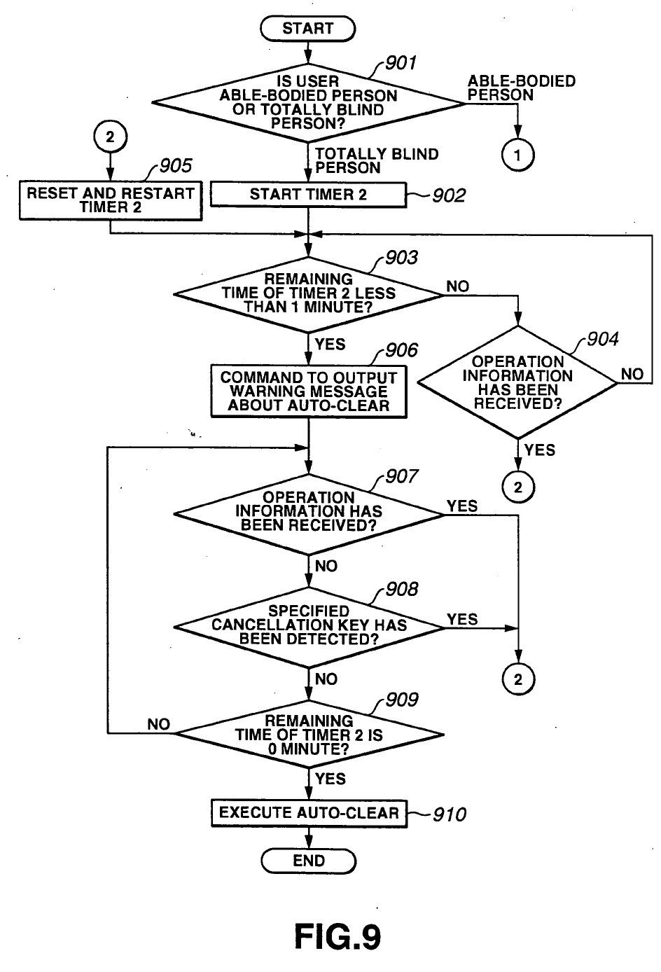

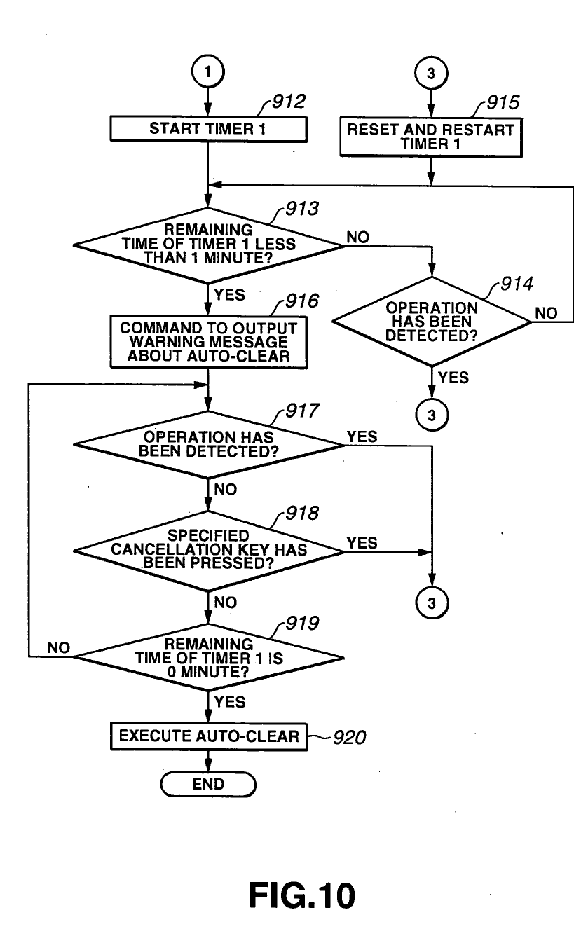

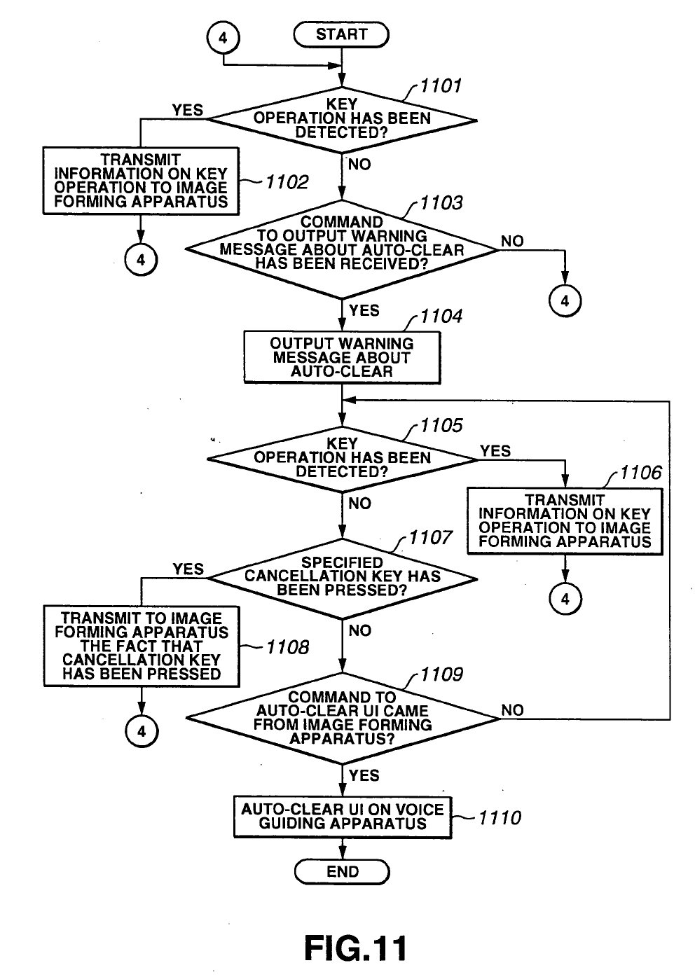

Next, an outline of a processing, which is executed when executing the auto-clear function for changing the settings back to the initial state when the operation is not performed for a fixed period of time in the information processing system 100, is explained with reference to FIG. 8, FIG. 9, FIG. 10, and FIG. 11.

FIG. 8 is a sequence diagram illustrating an outline of a processing of up until auto-clear is executed on the image forming apparatus 10 when, for example, a visually-impaired person operates the image forming apparatus 10 using the voice guiding apparatus 20 in the information processing system 100, the processing being executed by the image forming apparatus 10 and voice guiding apparatus 20.

In the image forming apparatus 10, when the visually-impaired person starts an operation, the timer 2-202 for a visually-impaired person is started.

When the operation is detected in the voice guiding apparatus 20, the timer 2-202 is reset and restarted from the time which was originally set, in the image forming apparatus 10.

If the remaining time of the timer 2-202 becomes less than a minute without detecting the operation in the voice guiding apparatus 20, a command to voice output a warning message from the image forming apparatus 10 to the voice guiding apparatus 20 is sent.

Specifically, the detail of the warning message is such that, for example, “if an operation is not carried out in another minute, the auto-clear function for changing the settings back to the initial state will be executed. If you do not wish to execute the auto-clear function, please carry out an operation within one minute, or press a specified cancellation key.”

If an operation is still undetected, a specified cancellation key (as will hereinafter be described) is not pressed, and the remaining time of the timer 2-202 becomes zero, the command to execute auto-clear for changing the settings back to the initial state is sent to the voice guiding apparatus 20, thereby executing auto-clear for changing the settings that are set in the image forming apparatus 10 back to the initial state.

FIG. 9 and FIG. 10 are flow charts illustrating a flow of processing in the image forming apparatus 10 of up until auto-clear is executed on the image forming apparatus 10.

In the image forming apparatus 10, an ID card for indicating that the user is, for example, a visually-impaired person is inserted, and it is judged whether the user is an able-bodied person or a visually-impaired person. If the user is a visually-impaired person after start the operation (visually-impaired person in Step 901), the timer 2-202, which is a timer for a visually-impaired person, is started (Step 902).

A time from starting the operation to executing auto-clear is set in advance in the timer 2-202, and by making the setting time different from that for the timer 1-201 for an able-bodied person, the time until execution of auto-clear can be set different from that for an able-bodied person.

When the timer 2-202 is started, information indicating that the application for a voice guide is operated in the voice guiding apparatus 20 is received (Step 904), and the timer 2-202 which is in operation is reset and restarted from the set original time (Step 905).

However, if the remaining time of the timer 2-202 becomes less than a minute when the operation information is not received from the voice guiding apparatus 20 and any operation performed by a visually-impaired person in the voice guiding apparatus 20 cannot be detected (Step 903), an output command for an auto-clear warning message is sent from the image forming apparatus 10 to the voice guiding apparatus 20 (Step 906).

Specifically, the auto-clear the warning message is such that, for example, “if an operation is not carried out in another minute, the auto-clear function for changing the settings back to the initial state will be executed. If you do not wish to execute the auto-clear function, please carry out an operation within one minute, or press a specified cancellation key.”

The specified cancellation key is set in advance in the image forming apparatus 10 and the voice guiding apparatus 20. By pressing the cancellation key, the timer in operation can be reset and restarted.

Further, the specified cancellation key may be a combination of plural keys and registered as a key for resetting and restarting and restarting the timer.

The timer 2-202 is reset and restarted (Step 905) in the case where the command to output a warning message is transmitted to the voice guiding apparatus 20 in Step 906, and thereafter the operation information is received from the voice guiding 20 (YES in Step 907), and it is detected that the specified cancellation key is pressed (YES in Step 908).

In the case where an operation of the specified cancellation key for resetting and restarting and restarting the timer 2-202 cannot be detected (NO in Step 908) without being able to detect the operation by the user (NO in Step 907), when the remaining time of the timer 2-202 becomes zero (YES in Step 909), auto-clear for clearing the contents set in the image forming apparatus 10 and changing them back to the initial state is executed, and a command to execute auto-clear for changing the contents set on the UI screen back to the initial state is sent to the voice guiding apparatus 20 as well (Step 910).

Moreover, when the user is an able-bodied person (able-bodied person in Step 901), the timer 1-201 for an able-bodied person is used for the timer for measuring the time for auto-clear to be executed (Step 912).

A time which is different from that of the timer 2-202 for a visually-impaired person is set in advance in the time 1-201 for an able-bodied person.

In the case as well where the timer 1-201 for an able-bodied person is used, an operation of the image forming apparatus 10 is not detected (NO in Step 914), and when the remaining time of the timer 1-201 becomes less than a minute (YES in Step 913), the warning message about execution of the auto-clear function is displayed in the user interface section 203 of the image forming apparatus 10 (Step 916).

Specifically, the warning message is such that, for example, “if an operation is not carried out in another minute, the auto-clear function for changing the settings back to the initial state will be executed. If you do not wish to execute the auto-clear function, please carry out an operation within one minute, or press a specified cancellation key.”

Furthermore, not only that the warning message is displayed in the user interface section 203, but also that the image forming apparatus 10 may be provided with a voice output mechanism so as to voice output the detail of the warning message.

After displaying the warning message in Step 916, when an operation is detected in the image forming apparatus 10 (YES in Step 917) or the specific cancellation key for resetting and restarting the timer 1-201 is pressed (YES in Step 918), the timer 1 is and restarted (Step 915).

Also after displaying the warning message in Step 916, if the remaining time of the timer 1 becomes zero (YES in Step 919) when an operation is not detected in the image forming apparatus 10 (NO in Step 917) and the specified cancellation key for resetting and restarting the timer 1 is not pressed (NO in Step 918), auto-clear is executed to change the settings, which are set in the user interface section 203, back to the initial state in the image forming apparatus 10 (Step 920).

Note that the processing in the image forming apparatus 10 in the information processing system 100 is explained in FIG. 9 and FIG. 10, image forming apparatus 10 being connected by means of the USB cable 30, but even when an able-bodied person uses the image forming apparatus 10 in a state where the image forming apparatus 10 is not connected to the voice guiding apparatus 20 by the USB cable 30, the explanations provided with reference to the flow charts of FIG. 9 and FIG. 10 can be applied.

Next, FIG. 11 is a flow chart illustrating a flow of processing in the voice guiding apparatus 20 of up until auto-clear is executed on the information processing system 100.

In the voice guiding apparatus 20 of the information processing system 100, when a key operation by a visually-impaired user is detected (YES in Step 1101), information about the key operation in the voice guiding apparatus 20 is transmitted from the voice guiding apparatus 20 to the image forming apparatus 10 (Step 1102).

In the image forming apparatus 10 which has received the information from the voice guiding apparatus 20, a result of YES is obtained in Step 904 or Step 908 as was described with reference to the flow chart of FIG. 9, whereby a processing of resetting the timer 2-202 is executed (Step 905).

However, if a key operation is not detected in the voice guiding apparatus 20 (NO in Step 1101) and a command to output the warning message about auto-clear is received from the image forming apparatus 10 (YES in Step 1103), the voice output section 303 voice outputs the warning message about auto-clear in a way that the visually-impaired person can understand (Step 1104).

Specifically, the warning message is such that, for example, “if an operation is not carried out in another minute, the auto-clear function for changing the settings back to the initial state will be executed. If you do not wish to execute the auto-clear function, please carry out an operation within one minute, or press a specified cancellation key.”

When a key operation is detected in the voice guiding apparatus 20 after the warning message is outputted (YES in Step 1105), information about the key operation is sent to the image forming apparatus 10 (Step 1106).

Further, when the specified cancellation key is pressed in the voice guiding apparatus 20 after the warning message is outputted in Step 1104 (YES in Step 1107), the fact that the specified key was pressed it transmitted from the voice guiding apparatus 20 to the image forming apparatus 10 (Step 1108).

However, if a command to perform auto-clear on the settings that are set in the UI screen 400 of the application for a voice guide is received from the image forming apparatus 10 when a key operation is not detected (NO in Step 1105) and the specified cancellation key is not pressed in the voice guiding apparatus 20 (NO in Step 1107), auto-clear for changing the setting on the UI screen 400 back to the initial state is executed (Step 1110).

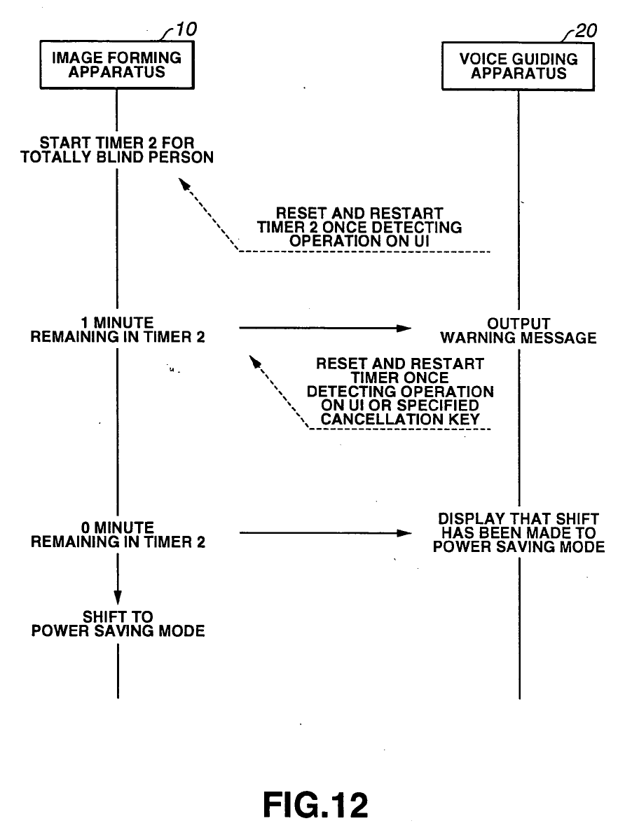

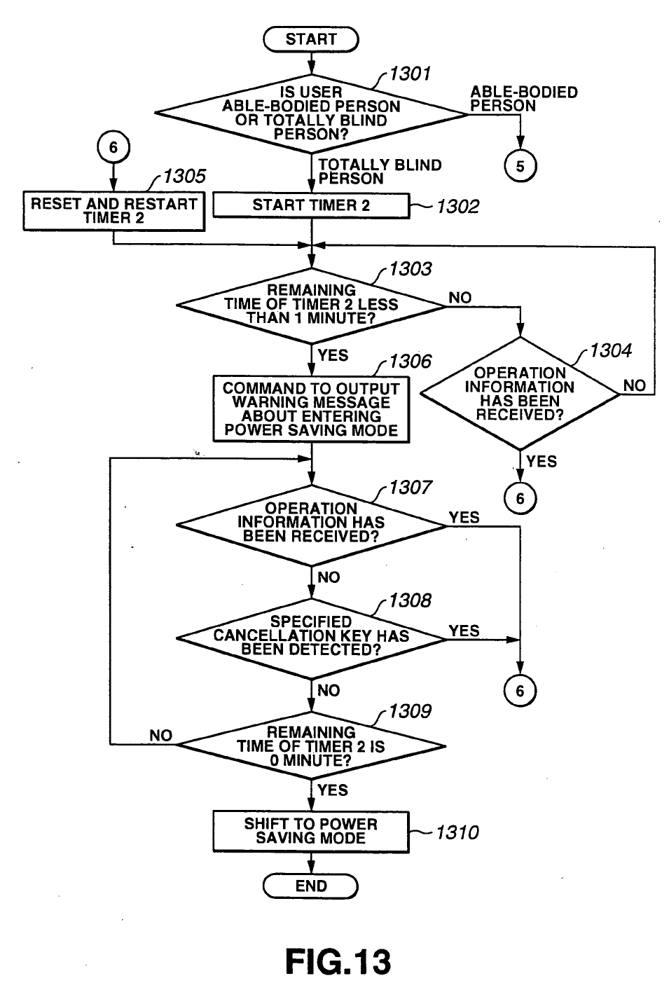

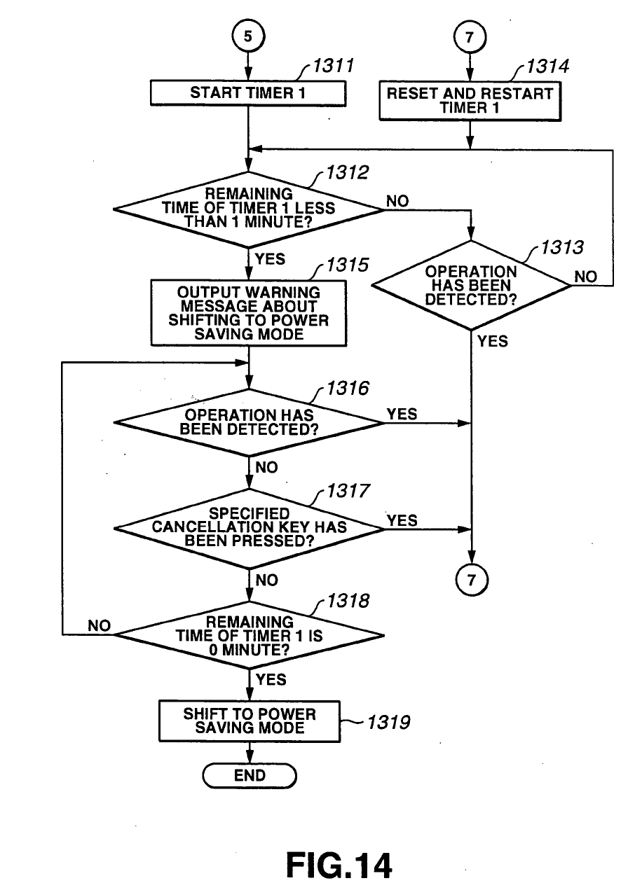

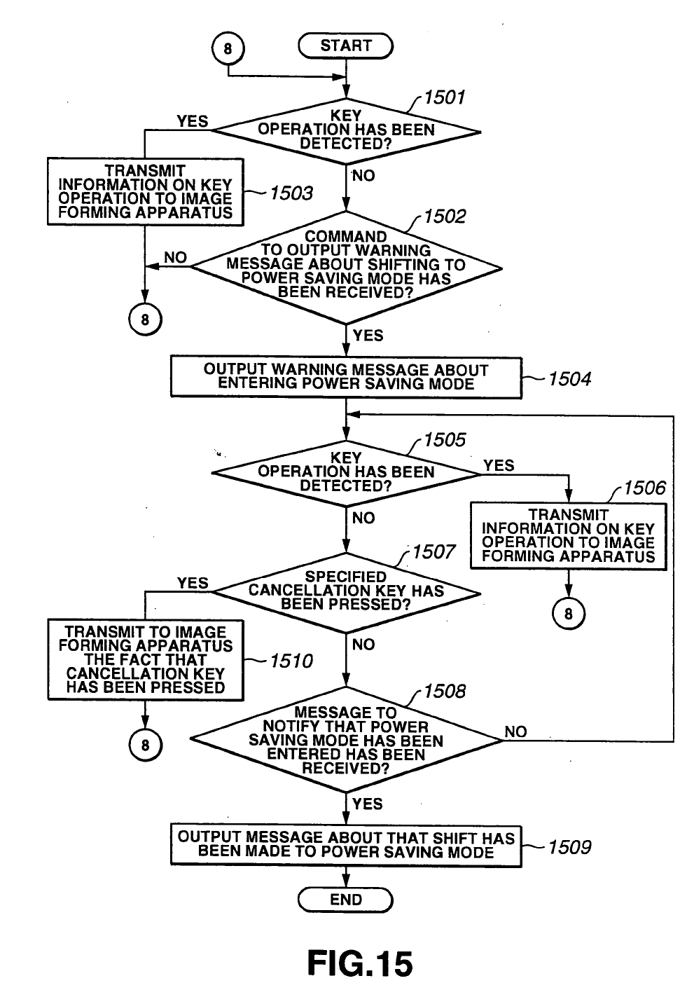

Next, an outline of the power saving control function, which reduces consumption in the electricity by fading out the display of the image forming apparatus 10 or shifting to a state called “power saving mode” for partially restraining the movement of the equipment if an operation is not performed for a fixed period of time in the information processing system 100, will now be described with reference to FIG. 12, FIG. 13, FIG. 14, and FIG. 15.

FIG. 12 is a sequence diagram illustrating an outline of processing of up until the image forming apparatus 10 is shifted to the power saving mode when, for example, a visually-impaired person operates the image forming apparatus 10 using the voice guiding apparatus 20 in the information processing system 100, the processing being executed by the image forming apparatus 10 and voice guiding apparatus 20.

In the image forming apparatus 10, when an operation is started by a visually-impaired person the timer 2-202 for a visually-impaired person is started.

When the operation is detected in the voice guiding apparatus 20, the timer 2-202 is reset in the image forming apparatus 10 and restarted from the set original time.

If the remaining time of the timer 2-202 becomes less than a minute while an operation remains undetected in the voice guiding apparatus 20, a command to voice output a warning message is sent from the image forming apparatus 10 to the voice guiding apparatus 20.

Specifically, the warning message is such that, for example, “if an operation is not carried out in another minute, the image forming apparatus in the process of setting is shifted to the power saving mode. If you do not wish to make the shift to the power saving mode, please carry out an operation within one minute, or press a specified cancellation key.”

If the remaining time of the timer 2-202 becomes zero when an operation is sill not detected and the specified cancellation key (cancellation key same as the cancellation key in the auto-clear function) is not pressed, the information on the shift to the power saving mode is transmitted from the image forming apparatus 10 to the voice guiding apparatus 20, whereby the image forming apparatus is shifted to the power saving mode.

FIG. 13 and FIG. 14 are flow charts illustrating a flow of processing in the image forming apparatus 10 of up until the image forming apparatus 10 is shifted to the power saving mode.

In the image forming apparatus 10, an ID card for indicating that the user is, for example, a visually-impaired person is inserted, and it is judged whether the user is an able-bodied person or a visually-impaired person. If the user is a visually-impaired person after starting the operation (visually-impaired person in Step 1301), the timer 2-202, which is a timer for a visually-impaired person, is started (Step 1302).

A time from starting the operation to shifting to the power saving mode is set in advance in the timer 2-202, and by making the setting time different from that for the timer 1-201 for an able-bodied person, the time until the shift is made to the power saving mode can be set different from that for an able-bodied person.

When the timer 2-202 is started, information indicating that the application for a voice guide is operated in the voice guiding apparatus 20 is received (YES in Step 1304), and the timer 2-202 which is in operation is reset and restarted from the set original time (Step 1305).

However, if the remaining time of the timer 2-202 becomes less than a minute (YES in Step 1303) when the operation information is not received from the voice guiding apparatus 20 and any operation performed by a visually-impaired person in the voice guiding apparatus 20 cannot be detected (NO in Step 1304), an output command of a warning message about shifting to the power saving mode is sent from the image forming apparatus 10 to the voice guiding apparatus 20 (Step 1306).

Specifically, the warning message is such that, for example, “if an operation is not carried out in another minute, the image forming apparatus in the process of setting is shifted to the power saving mode. If you do not wish to make the shift to the power saving mode, please carry out an operation within one minute, or press a specified cancellation key.”

The timer 2-202 is reset and restarted (Step 1305) in the case where the command to output a warning message is transmitted to the voice guiding apparatus 20 in Step 1306, and thereafter the operation information is received from the voice guiding 20 (YES in Step 1307), and it is detected that the specified cancellation key is pressed (YES in Step 1308).

In the case where an operation of the specified cancellation key for resetting and restarting the timer 2-202 cannot be detected (NO in Step 1308) without being able to detect the operation by the user (NO in Step 1307), when the remaining time of the timer 2-202 becomes zero (YES in Step 1309), the image forming apparatus 10 transmits to the voice guiding apparatus 20 the information on the shift to the power saving mode is made, and is shifted to the power saving mode (Step 1310).

Moreover, when the user is an able-bodied person (able-bodied person in Step 1301), the timer 1-201 for an able-bodied person is used for the timer for measuring the time until the shift is made to the power saving mode (Step 1311).

A time which is different from that of the timer 2-202 for a visually-impaired person is set in advance in the time 1-201 for an able-bodied person.

In the case as well where the timer 1-201 for an able-bodied person is used, an operation of the image forming apparatus 10 is not detected (NO in Step 1313), and when the remaining time of the timer 1-201 becomes less than a minute (YES in Step 1312), the warning message about shifting to the power saving mode is displayed in the user interface section 203 of the image forming apparatus 10 (Step 1315).

Specifically, the warning message is such that, for example, “if an operation is not carried out in another minute, the shift will be made to the power saving mode. If you do not wish to make the shift to the power saving mode, please carry out an operation within one minute, or press a specified cancellation key.”

Furthermore, not only that the warning message is displayed in the user interface section 203, but also that the image forming apparatus 10 may be provided with a voice output mechanism so as to voice output the detail of the warning message.

After displaying the warning message in Step 1315, when an operation is detected in the image forming apparatus 10 (YES in Step 1316) or the specific cancellation key for resetting and restarting the timer 1-201 is pressed (YES in Step 1317), the timer 1 is and restarted (Step 1314).

Also after displaying the warning message in Step 1315, if the remaining time of the timer 1 becomes zero (YES in Step 1318) when an operation is not detected in the image forming apparatus 10 (NO in Step 1316) and the specified cancellation key for resetting and restarting the timer 1 is not pressed (NO in Step 1317), the image forming apparatus 10 is shifted to the power saving mode (Step 1319).

Note that the processing in the image forming apparatus 10 in the information processing system 100 is explained in FIG. 13 and FIG. 14, image forming apparatus 10 being connected by means of the USB cable 30, but even when an able-bodied person uses the image forming apparatus 10 in a state where the image forming apparatus 10 is not connected to the voice guiding apparatus 20 by the USB cable 30, the explanations provided with reference to the flow charts of FIG. 13 and FIG. 14 can be applied.

When the information about that the voice guiding apparatus 20 is operated is received from the voice guiding apparatus 20 after the image forming apparatus 10 is shifted to the power saving mode, the image forming apparatus 10 is shifted to the power saving mode as was explained about the processing for canceling the power saving mode of the image forming apparatus 10 with reference to FIG. 6.

Next, FIG. 15 is a flow chart illustrating a flow of processing in the voice guiding apparatus 20 of up until the image forming apparatus 10 is shifted to the power saving mode in the information processing system 100.

In the voice guiding apparatus 20 of the information processing system 100, when a key operation by a visually-impaired user is detected (YES in Step 1501), information about the key operation in the voice guiding apparatus 20 is transmitted from the voice guiding apparatus 20 to the image forming apparatus 10 (Step 1503).

In the image forming apparatus 10 which has received the information from the voice guiding apparatus 20, a result of YES is obtained in Step 1304 or Step 1307 as was described with reference to the flow chart of FIG. 13, whereby a processing of resetting the timer 2-202 is executed (Step 1305).

However, if a key operation is not detected in the voice guiding apparatus 20 (NO in Step 1501) and a command to output the warning message about shifting to the power saving mode is received from the image forming apparatus 10 (YES in Step 1502), the voice output section 303 voice outputs the warning message about the shifting to the power saving mode in a way that the visually-impaired person can understand (Step 1504).

Specifically, the warning message is such that, for example, “if an operation is not carried out in another minute, the image forming apparatus 10 in the process of setting is shifted to the power saving mode. If you do not wish to make the shift to the power saving mode, please carry out an operation within one minute, or press a specified cancellation key.”

When a key operation is detected in the voice guiding apparatus 20 after the warning message is outputted (YES in Step 1505), information about the key operation is sent to the image forming apparatus 10 (Step 1506).

Further, when the specified cancellation key is pressed in the voice guiding apparatus 20 after the warning message is outputted in Step 1504 (YES in Step 1507), the fact that the specified key was pressed it transmitted from the voice guiding apparatus 20 to the image forming apparatus 10 (Step 1510).

However, if a notification of information about that the shift has been made to the power saving mode is received from the image forming apparatus 10 (YES in Step 1508) when a key operation is not detected (NO in Step 1505) and the specified cancellation key is not pressed in the voice guiding apparatus 20 (NO in Step 1507), the voice output section 303 voice outputs a message about that the image forming apparatus has been shifted to the power saving mode (Step 1509).

The message which expresses that the shift has been made to the power saving mode is such that “the image forming apparatus in the process of setting has been shifted to the power saving mode due to no operation performed for a fixed period of time. If an operation is performed from the application for a voice guide, the shift of the image forming apparatus to the power saving mode will be canceled.”

As indicated in this message, if an operation is performed in the voice guiding apparatus 20 and the operation information is transmitted from the voice guiding apparatus 20 to the image forming apparatus 10 even after the image forming apparatus 10 is shifted to the power saving mode, the image forming apparatus 10 cancels the power saving mode as was explained about the processing for canceling the power saving mode of the image forming apparatus with reference to FIG. 6.

The timer for an able-bodied person or the timer for a visually-impaired person may be used to activate the auto-clear function to execute it, and thereafter started as a time for activating the power saving control function, so as to execute the power saving control function after executing the auto-clear function by means of a single device.

In FIG. 8, Steps 904, 907 and 908 of FIG. 9, Steps 1101, 1105 and 1107 of FIG. 11, FIG. 12, Steps 1304, 1307 and 1308 of FIG. 13, and Steps 1501, 1505 and 1507 of FIG. 15, when detecting an operation by a user and detecting an operation of the cancellation key, these things may be performed by detecting not only an operation in the voice guiding apparatus 20 but also an operation in the image forming apparatus 10, in consideration of a situation where an able-bodied person helps a visually-impaired person with an operation.

### Embodiment 2

The information processing system having a configuration in which the image forming apparatus 10 as an information processing apparatus comprises the timer 1-201 for an able-bodied person and the timer 2-202 for a visually-impaired person was explained in Embodiment 1. The present embodiment on the other hand describes a processing of the auto-clear function and power saving control function in an information processing system having a configuration in which the image forming apparatus 10 comprises a timer for an able-bodied person and the voice guiding apparatus 20 comprises a timer for a visually-impaired person.

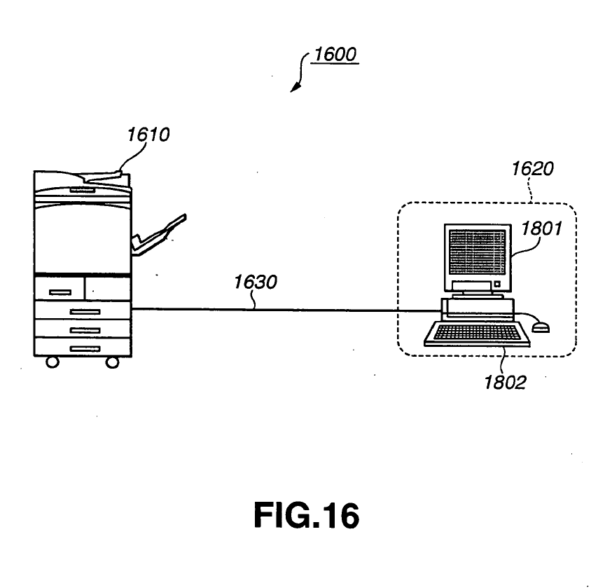

FIG. 16 is a system configuration diagram illustrating an outline of an information processing system 1600 related to the present invention.

As shown in FIG. 16, in the information processing system 1600, a voice guiding apparatus 1620 comprising a timer for a visually-impaired person is connected to an image forming apparatus 1610 as an information processing apparatus which comprises a timer for an able-bodied person by a USB cable 1630.

The image forming apparatus 1610 comprises plural functions such as a duplication function, facsimile function, scanning function and the like.

Further, the voice guiding apparatus 1620, which comprises a timer for a visually-impaired person, is constituted with a personal computer, has an application for a voice guide installed therein so that an visually-impaired person can operated the image forming apparatus 1610, and is constituted such that the application for a voice guide inputted from an input device 1802 and operated is displayed on a display 1801.

A visually-impaired person uses the personal computer which constitutes the voice guiding apparatus 1620 to operate the image forming apparatus 1610, and an able-bodied person uses a touch panel, which is a UI attached onto the image forming apparatus 1610, to operate the image forming apparatus 1610.

The image forming apparatus 1610 and the voice guiding apparatus 1620 are connected by the USB cable and exchange information.

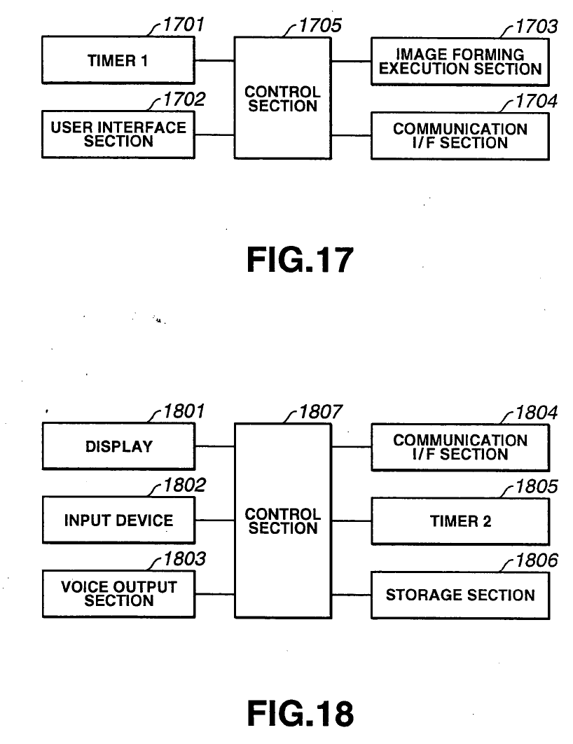

Next, an outline of the configuration of the image forming apparatus 1610 is explained with reference to FIG. 17.

FIG. 17 is a block diagram illustrating an example of a configuration of the image forming apparatus 1610 in the present embodiment.

The image forming apparatus 1610 is constituted by a timer 1-1701 described in Claims 5 and 9, which is a timer for timing a first time and for informing an able-bodied person of the passage of time taken for auto-clear and for making the shift to the power saving mode, a user interface section 1702 which is a touch panel screen on which the able-bodied person performs various parameter settings in an image forming processing, an image forming execution section 1703 which is responsible for various image forming functions such as a duplication function, facsimile function, scanning function, copy function and the like in the image forming apparatus 1610, a communication interface section 1704 (abbreviated as “communication I/F section 1704” hereinafter) to which a connector of the USB cable is connected from the voice guiding apparatus 1620 is connected so as to exchange information with the voice guiding apparatus 1620, and a control section 1705 which is connected to each constituent section and controls each constituent section.

If the USB cable 1630 is connected from the voice guiding apparatus 1620 to the communication I/F section 1704, the control section 1705 can detect the connection.

Next, an outline of the configuration of the voice guiding apparatus 1620 is explained with reference to FIG. 18.

FIG. 18 is a block diagram illustrating an example of a configuration of a voice guiding apparatus 1620 in the present embodiment.

The voice guiding apparatus 1620 is constituted by the display 1801 which is responsible for functions including display of the UI screen of the application for a voice guide to, for example, the visually-impaired person, an input device 1802 such as a keyboard serving as a device in which the visually-impaired person inputs information into the UI screen, a voice output section 1803 for informing the visually-impaired person of an operational state on the UI screen displayed on the display 1801, by voice, in order for an operation of the image forming apparatus 1610, a communication interface section 1804 (abbreviated as “communication I/F section 1804” hereinafter) which is connected to the image forming apparatus 1610 by the USB cable 1630 and exchanges information with the image forming apparatus 1610, a timer 2-1805 described in Claims 5 and 9, which is a timer for timing a second time and for informing a visually-impaired person of the passage of time taken for auto-clear and for making the shift to the power saving mode, a storage section 1806 in which the application for a voice guide is stored, and a control section 1807 which is connected to each constituent section and controls each constituent section.

The UI screen of the application for a voice guide which is displayed on the display 1801 of the voice guiding apparatus 1620 is same as the UI screen 400 which is described in Embodiment 1 with reference to FIG. 4, thus the explanation thereof is omitted in the present embodiment, for avoiding duplication.

Further, the processing of the voice guiding apparatus 1620 which is executed when the voice guiding apparatus 1620 is connected to the image forming apparatus 1610 using the USB cable 1630 is same as the processing executed for the voice guiding apparatus 20 when connecting the voice guiding apparatus 20 to the image forming apparatus 10 using the USB cable 30, the processing being described in Embodiment 1 with reference to FIG. 5, thus the explanation there of is omitted in the present embodiment, for avoiding duplication.

Furthermore, the processing of the image forming apparatus 1610 which is executed when the USB cable 1630 is used to connect the voice guiding apparatus 1620 to the image forming apparatus 1610 shifting to the power saving mode is same as the processing of the image forming apparatus 10 which is executed when the USB cable 30 is used to connect the voice guiding apparatus 20 to the image forming apparatus 10 shifting to the power saving mode, the processing being described in Embodiment 1 with reference to FIG. 6, thus the explanation there of is omitted in the present embodiment, for avoiding duplication.

Also the processing, which is executed when inserting a connector of the USB cable connected to the voice guiding apparatus 1620 into the image forming apparatus 1610 shifting to the power saving mode, is same as the processing of the image forming apparatus 10 which is executed when inserting the connector of the USB cable connected to the voice guiding apparatus 20 into the image forming apparatus 10 shifting to the power saving mode, the processing being described in Embodiment 1 with reference to FIG. 7, thus the explanation there of is omitted in the present embodiment, for avoiding duplication.

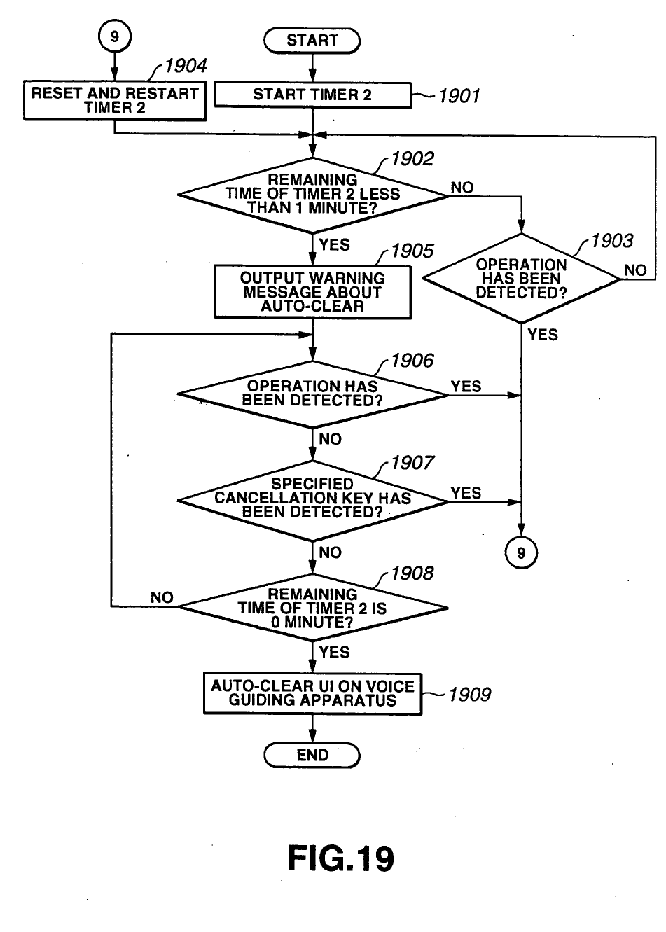

Next, a processing in the voice guiding apparatus 1620 of up until auto-clear is executed on the information processing system 1600 is now described with reference to FIG. 19.

FIG. 19 is a flow chart shoring a flow of processing in the voice guiding apparatus 1620 of up until auto-clear is executed on the information processing system 1600.

When the application for a voice guide is started up in the voice guiding apparatus 1620, the timer 2-1805 is started (Step 1901).

Then, in the voice guiding apparatus 1620, when an operation of the application for a voice guide is detected on the UI screen 400 before the remaining time of the timer becomes less than a minute (YES in Step 1903), the timer 2-1805 is reset and restarted from the set original time (Step 1904).

If the remaining time of the timer 2-1805 becomes less than a minute (YES in Step 1902) when an operation of the application for a voice guide is not detected (NO in Step 1903), the voice output section 1803 voice outputs a warning message about executing auto-clear (Step 1905).

Specifically, the warning message is such that, for example, “if an operation is not carried out in another minute, the user interface screen in the process of setting executes the auto-clear function for changing the settings back to the initial state. If you do not wish to execute the auto-clear function, please carry out an operation within one minute, or press a specified cancellation key.”

The specified cancellation key is set in advance in the image forming apparatus 1610 and the voice guiding apparatus 1620. By pressing the cancellation key, the timer in operation can be reset.

Further, the specified cancellation key may be a combination of plural keys and registered as a key for resetting and restarting the timer.

When an operation of the application for a voice guide is detected (YES in Step 1906) or the specified cancellation key is pressed (YES in Step 1907) before the remaining time of the timer 2-1805 becomes zero (NO in Step 1908), the timer 2-1805 is reset and restarted from the set original time (Step 1904).

If the remaining time of the timer 2-1805 becomes zero (YES in Step 1908) when an operation of the application for a voice guide is not detected (NO in Step 1906) and the specified cancellation key is not pressed (NO in Step 1907) after the warning message about auto-clear is outputted in Step 1905, the voice guiding apparatus 1620 sends a notification that auto-clear is executed to the image forming apparatus 1610 to cause the image forming apparatus 1610 to execute auto-clear for changing the settings that are set by a user in the UI screen of the application for a voice guide back into the initial state (Step 1909).

The image forming apparatus 1610, which has received from the voice guiding apparatus 1620 the notification of executing the auto-clear function, then executes auto-clear for changing, back to the initial state, the parameter settings that are the same as the settings set on the application for a voice guide in the voice guiding apparatus 1620, upon transmission of operation information from the voice guiding apparatus 1620.

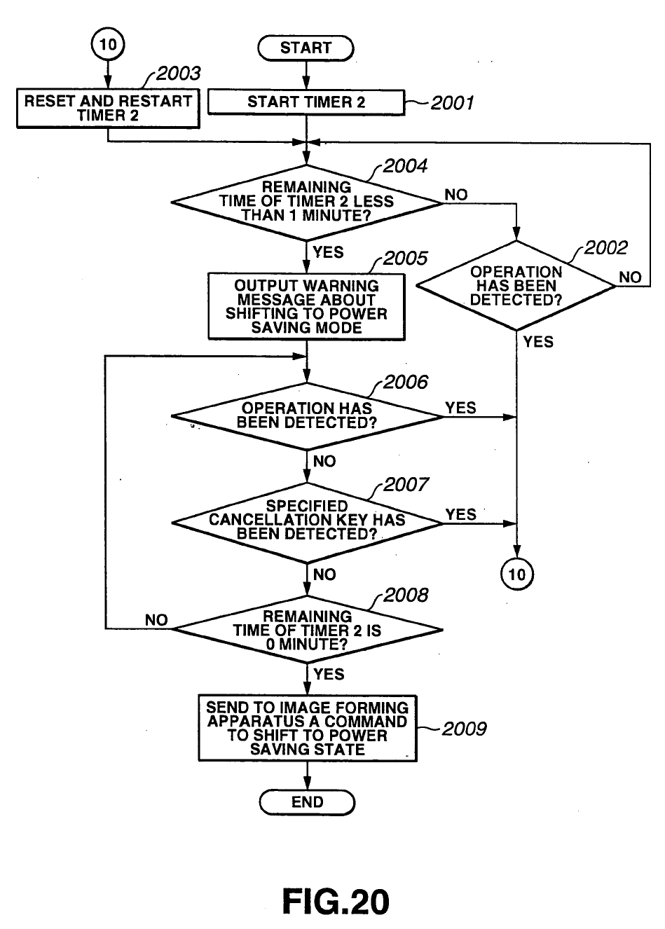

A processing in the voice guiding apparatus 1620 of up until the image forming apparatus 1610 is shifted to the power saving mode in the information processing system 1600 is not described with reference to FIG. 20.

FIG. 20 is a flow chart illustrating a flow of processing in the voice guiding apparatus 1620 of up until the image forming apparatus 1610 is shifted to the power saving mode in the information processing system 1600.

When the application for a voice guide is started up in the voice guiding apparatus 1620, the timer 2-1805 is started (Step 2001).

Then, in the voice guiding apparatus 1620, when an operation of the application for a voice guide is detected before the remaining time of the timer becomes less than a minute (YES in Step 2002), the timer 2-1805 is reset and restarted from the set original time (Step 2003).

If the remaining time of the timer becomes less than a minute (YES in Step 2004) when an operation of the application for a voice guide is not detected (NO in Step 2002), the voice output section 1803 voice outputs a warning message about shifting to the power saving mode (Step 2005).

Specifically, the warning message is such that, for example, “if an operation is not carried out in another minute, the image forming apparatus in the process of setting is shifted to the power saving mode. If you do not wish to make the shift to the power saving mode, please carry out an operation within one minute, or press a specified cancellation key.”

When an operation of the application for a voice guide is detected (YES in Step 2006) or the specified cancellation key is pressed (YES in Step 2007) before the remaining time of the timer becomes zero (NO in Step 2008), the timer 2-1805 is reset and restarted from the set original time (Step 2003).

If the remaining time of the timer becomes zero (YES in Step 2008) when an operation of the application for a voice guide is not detected (NO in Step 2006) and the specified cancellation key is not pressed (NO in Step 2007) after the warning message about shifting to the power saving mode is outputted in Step 2005, the voice guiding apparatus 1620 transmits to the image forming apparatus 1610 a command to shift the power saving mode (Step 2009), and the voice output section 1803 voice outputs a message about that the image forming apparatus 1610 has been shifted to the power saving mode (Step 2010).

The image forming apparatus 1610, which has received from the voice guiding apparatus 1620 the command to make the shift to the power saving mode, is shifted to the power saving mode.

The message which tells the visually-impaired person that the shift has been made to the power saving mode is such that “the image forming apparatus in the process of setting has been shifted to the power saving mode due to no operation performed for a fixed period of time. If an operation is performed from the application for a voice guide, the shift of the image forming apparatus to the power saving mode will be canceled.”

As indicated in this message, if an operation is performed in the voice guiding apparatus 1620 even after the image forming apparatus 1610 is shifted to the power saving mode, operation information is transmitted from the voice guiding apparatus 1620 to the image forming apparatus 1610, and the image forming apparatus 1610 cancels the power saving mode as was explained about the processing for canceling the power saving mode of the image forming apparatus with reference to FIG. 6.

The timer 2-1805 may be used to activate the auto-clear function to execute it, and thereafter started as a time for activating the power saving control function, so as to execute the power saving control function after executing the auto-clear function by means of a single device.

In Steps 1903 and 1906 of FIG. 19, and Steps 2002 and 2006 of FIG. 20, when detecting an operation by a user and detecting an operation of the cancellation key, these things may be performed by detecting not only an operation in the voice guiding apparatus 1620 but also an operation in the image forming apparatus 1610, in consideration of a situation where an able-bodied person helps a visually-impaired person with an operation.

The present invention can be used in the information processing system in which, for example, a visually-impaired person can operate various information processing apparatuses by using the voice guiding apparatus.

According to the present invention, the information processing system comprising the power saving control function and/or auto-clear function in which, for example, an able-bodied person and a visually-impaired person can comfortably use the information processing apparatus is provided.

The entire disclosure of Japanese Patent Application No. 2004-345499 filed on Nov. 30, 2004 including specification, claims, drawings and abstract is incorporated herein by reference in its entirety.

What is claimed is:

1. An information processing apparatus comprising:
a first timer that times a first time;
a second timer that times a second time which is different from the first time; and
a switching unit that switches, in accordance with a user, between a first power saving control mode in which shift is made to the power saving mode if no operation is performed for a period of the first time, and a second power saving control mode in which shift is made to the power saving mode if no operation is performed for a period of the second time timed by the second timer.

2. The information processing apparatus according to claim 1, further comprising a voice guiding unit that guides by voice that a remaining time of the first timer or the second timer becomes a predetermined period of time or less.

3. An information processing apparatus comprising:
a first timer for timing a first time;
a second timer for timing a second time which is different from the first time; and
a switching unit that switches, in accordance with the user, between a first auto-clear control mode which initializes settings which are set through operations by the user if no operation is performed for a period of the first time, and a second auto-clear control mode which initializes the settings which are set through operations by the user if no operation is performed for a period of the second time timed by the second timer.

4. The information processing apparatus according to claim 3, further comprising a voice guiding unit that guides by voice that remaining time of the first timer or the second timer becomes a predetermined period of time or less.

5. An information processing system comprising:
an information processing apparatus having a first timer that times a first time and makes shift to a power saving mode if no operation is performed for a period of the first time timed by the first timer; and
a voice guiding apparatus that is connected to the information processing apparatus and performs a voice guide for the information processing apparatus, wherein
the voice guiding apparatus comprises:
a second timer that times a second time which is different from the first time;
a power saving mode controller that shifts the information processing apparatus to the power saving mode if no operation is performed for a period of the second time timed by the second timer in a state in which the voice guiding apparatus is connected to the information processing apparatus; and
a voice guiding unit that guides by voice that a remaining time of the second timer becomes a predetermined period of time or less.

6. An information processing system comprising:
an information processing apparatus which makes shift to a power saving mode if no operation is performed for a predetermined period of time;
a voice guiding apparatus that is connected to the information processing apparatus and performs voice guide for the information processing apparatus;
a connection detecting unit that detects a connection between the information processing apparatus and the voice guiding apparatus; and
a cancellation unit that automatically cancels a power saving mode when a connection between the information processing apparatus and the voice guiding apparatus is detected by the connection detecting unit in a state in which the information processing apparatus is in the power saving mode.

7. An information processing system comprising:
an information processing apparatus that makes shift to a power saving mode if no operation is performed for a predetermined period of time;
a voice guiding apparatus that is connected to the information processing apparatus and performs voice guide for the information processing apparatus;
a connection detecting unit that detects a connection between the information processing apparatus and the voice guiding apparatus;
a communication unit that makes a communication between the information processing apparatus and the voice guiding apparatus; and
a cancellation unit that automatically cancels a power saving mode when a connection with the voice guiding apparatus is detected by the connection detecting unit and when a communication is established between the information processing apparatus and the voice guiding apparatus by the communication unit in a state in which the information processing apparatus is in the power saving mode.

8. An information processing system comprising:
an information processing apparatus that makes shift to a power saving mode if no operation is performed for a predetermined period of time timed by a timer;
a voice guiding operating device that is connected to the information processing apparatus and performs voice guide for the information processing apparatus and operations of the information processing apparatus;
a connection detecting unit that detects a connection between the information processing apparatus and the voice guiding operating device;
a communication unit that makes a communication between the information processing apparatus and the voice guiding operating device;
an operation detecting unit that detects an operation of the voice guiding operating device;
a notifying unit that notifies the information processing apparatus of an output detected by the operation detecting unit via the communication unit; and
a timer controller that resets and restarts the timer on the basis of notification of the notifying unit.

9. An information processing system comprising:
an information processing apparatus having a first timer that times a first time and initializes settings which are set through operation by a user if no operation is performed for a period of the first time timed by the first timer; and
a voice guiding apparatus that is connected to the information processing apparatus and performs voice guide for the information processing apparatus, wherein
the voice guiding apparatus comprises:
a second timer that times a second time which is different from the first time;
an auto-clear controller that initializes the settings which are set through operation by a user on the information processing apparatus if no operation is performed for a period of the second time timed by the second timer in a state in which the voice guiding apparatus is connected to the information processing apparatus; and
a voice guiding unit that guides by voice that a remaining time of the second timer becomes a predetermined period of time or less.

10. An information processing system comprises:
an information processing apparatus that initializes settings which are set through operation by a user if no operation is performed for a predetermined period of time timed by a timer;
a voice guiding operating device that is connected to the information processing apparatus and performs voice guide for the information processing apparatus and operations of the information processing apparatus;
a connection detecting unit that detects a connection between the information processing apparatus and the voice guiding operating device;
a communication unit that makes a communication between the information processing apparatus and the voice guiding operating device;
an operation detecting unit that detects an operation of the voice guiding operating device;
a notifying unit that notifies the information processing apparatus of an output detected by the operation detecting unit via the communication unit; and
a timer controller that resets and restarts the timer on the basis of notification of the notifying unit.
